(19) United States
(12) Patent Application Publication
(10) Pub. No.: US 2004/0151573 A1
(43) Pub. Date: Aug. 5, 2004

(54) Common carrier baggage method

(76) Inventor: David D. Estes, Alexandria, VA (US)

Correspondence Address: Joseph M. Gusmano, Esq., Weinstock, Friedman & Friedman, P.A., 4 Reservior Circle, Baltimore, MD, 21208, US

(21) Appl. No.: 10/641,466

(22) Filed: Aug. 15, 2003

Related U.S. Application Data
(60) Provisional application No. 60/445,215, filed on Feb. 5, 2003.

(51) Int. Cl. B65F 9/00

(52) U.S. Cl. 414/809

(57) ABSTRACT

In the context of a passenger common carrier system, a method for the secure and convenient handling of luggage employing a parcel carrier system. Baggage is entrusted to a parcel carrier with sufficient time for shipment to the destination terminal or final destination of the passenger, who then converts a baggage check system to a parcel waybill system, transports the resulting parcel, converts the parcel back to baggage, then returns it to the common carrier for delivery to the passenger. In a variation of the method, the parcel carrier transports the parcel to the final destination of the passenger before converting the parcel back into baggage.

### CROSS REFERENCE TO RELATED APPLICATIONS

This application is from provisional application Ser. No. 60/445,215 filed on Feb. 5, 2003, incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention relates to a method for receiving and handling a large deal of baggage that passengers who are to use a common carrier for transportation, and in particular, a method for retrieving baggage prior to the departure of the passenger, and conveying it on a parcel carrier system instead of the common carrier system.

2. Description of the Related Art

Recent terrorist activities involving commercial airlines, ocean liners, and other commercial carriers, have created a demand and a public mandate for more effective security solutions to these hazards. Systems have been created which attempt to solve this problem by matching passengers with their luggage. Under these systems, baggage checked by passengers who fail to board the aircraft is identified and removed. However, such security systems require a great amount of time and expense to implement.

The most frequent and dangerous menace for security is the bomb threat. According to the National Transportation Safety Board, the bomb threats only in US airports during 1993-1995 amounted to an average of 300 threats per year, almost each and every day. It would therefore be of great advantage to airports to reduce the amount of baggage that each passenger takes to the departure terminal or retrieves from the arrival terminal.

These security issues, which can arise on any common carrier but are most newsworthy among commercial airlines, has been partially solved by two current main ways: first, seeking detection and screening of explosives while passenger and baggage processing, and, if unsuccessfully, second, bomb damage mitigating by use of constructive features of cargo hold to make it bomb-proof through hardening and fast decompressing. However, both ways had and still have significant drawbacks: they are complex, expensive, though yet unreliable and ineffective.

By way of example, a system for passenger and luggage processing at commercial airports in U.S. Pat. No. 4,137,567 to Grube, Jan. 30, 1979, has all cited drawbacks of the first way. It is imperfectness of detecting methods and means themselves, including even sniffing dogs, and inadequate diligence of staff lacking vigilance owing to facing permanently a check of a multitude of passengers and baggage for limited time, comparative infrequency of real dangerous events, and very low salary.

By way of further example, air cargo container with bomb damage mitigation features in U.S. Pat. No. 5,195,701 to Willan, Mar. 23, 1993, has venting device to pierce the fuselage wall of an airplane and vent shock waves and gas outside. While it is believable the device pierces the fuselage, though hardly—or even not—harmlessly for the airplane, there is no assurance that all of gas and shock waves would leave through this hole proposed, and the airplane would not undergo any dangerous impacts.

By way of yet a further example, an airport normally has a plurality of arrival and departure platforms from which airplanes successively arrive in and depart well. Meanwhile, a passenger commonly arrives at an airport well before a departure time of the passenger's flight. In any airport, there are usually a large number of passengers who are attempting to board, one of flights and thus the extent of their baggage at one time can cause confusion.

In airports, security checks are performed on not only passengers before boarding passenger planes but also their checked baggage in order to ensure flight safety and prevent crimes. In conventional baggage handling systems in airport, a security check of baggage is usually made after the baggage is checked at a check-in desk. Then, the baggage that has passed a security check is sorted into corresponding airplanes and put thereon. If the baggage is rejected in the safety check, alternatively, a passenger being the owner of the baggage is paged through a public-address system in the airport to check it up for himself and remove a cause of rejection.

The conventional baggage handling system in airport mentioned above, however, has the following problems. The first problem is that the amount of baggage (i.e., the number of bags and other objects) to be handled has increased as airline travel has become more popular. Thus, the management of baggage has become more complicated.

The second problem is in the inefficiency in coping with a situation where baggage is rejected at the time of a security check. In detail, even if the passenger who owns the rejected baggage is paged through a public-address system in the airport, he will not always appear immediately. This has caused an inconvenience that baggage rejected at a security check must be kept until its owner appears to address the cause of rejection. The owner of the baggage often does not appear immediately in response to the paging because he utilizes shops, restaurants, etc. in the airport.

Usually, the baggage that has passed the security check is designated for the appropriate airplane and loaded thereon. There is, however, a case that the owner of the baggage already loaded on an airplane does not get on the airplane even up to a departure time. In this case, the baggage must be discharged from the airplane prior to departure in order to prevent any possible problem because of the absent passenger's baggage being the airplane. Even if there is no possibility of a crime caused by this baggage, it becomes troublesome to promptly return the baggage back to its owner if the baggage has been loaded on a wrong flight. It is not preferable for distinction between passenger flight and cargo flight. However, since such case is not considered when baggage is loaded on the airplane, the baggage that must be discharged therefrom is sometimes put deep inside of a storage room of the airplane, thus making removal of this baggage difficult.

### SUMMARY OF THE INVENTION

Accordingly, several main objects and advantages of my invention are its reliability, effectiveness, simplicity, and cheapness, providing satisfaction of the vital existing wants and needs of society for dependable aviation safety and security, and accompanied by: eliminating or reducing expenditures and inconvenience of long troublesome baggage check; increasing the seating capacity on the airplane; savings in costs of the baggage carriage; enlarging nonstop flight range.

The present invention has been made in view of the above circumstances and has an object to overcome the above problems and to provide a common carrier baggage receiving and handling method capable of efficiently handling the baggage of the common carrier.

The second object of the present invention is providing a method whereby a parcel carrier system is modified in a novel manner to make it amenable to incorporation with the baggage handling requirements of a common carrier.

The third object of the present invention is to provide a method for determining the proper lead time window for a parcel carrier to accept or deliver baggage to be amenable to the present method.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

### BRIEF DESCRIPTION OF THE DRAWINGS

These and other objects, features, and advantages of the present invention will become more apparent from the following detailed description of the preferred embodiments and certain modifications thereof when taken together with the accompanying drawings in which:

FIG. 1, is a flowchart of the method of the present invention according to one preferred embodiment of it.

FIG. 2, is a flowchart of the method of the present invention according to a second preferred embodiment of it.

### DETAILED DESCRIPTION OF THE PREFERRED EMBODIMENTS

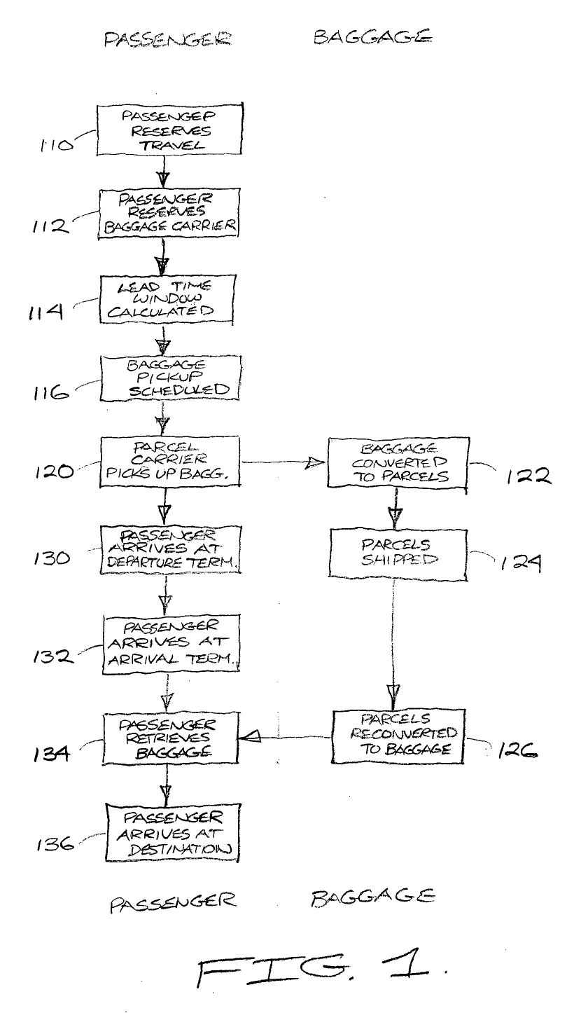

Referring now to FIG. 1, and in a preferred embodiment of the present invention, a passenger having one or more articles of baggage, or baggage items, is at a departure location, such as their home or office, at the time the present method is initiated. The passenger's intent is to be rejoined with the articles of baggage items at a destination location, such as a resort or a business meeting. In all embodiments of the present invention, the passenger travels from the departure location to a departure terminal location, such as a commercial airport, then by means of a common carrier to a destination terminal location, such as a second commercial airport, and then to the destination location.

It will be apparent to one of ordinary skill in the relevant art of the invention that although there is great interest in air transportation safety and that the present invention can be used to promote safety, there is nothing in the present invention to preclude use of the present method in rail transportation, road transportation, or marine transportation common carriers, or for multi-modal transportation purposes, such as when air transportation is coordinated with motorcoach transportation by the same carrier.

Furthermore, there is nothing in the present invention to preclude the use of methods of the present invention for purposes other than promoting safety, such as adding convenience to the passenger or decreasing the cost of passenger travel by common carrier, and promoting market opportunities and growth for the parcel carrier industry.

At the inception of the present embodiment of the invention, the passenger reserves travel on a common carrier in step 110. The result is an itinerary having departure and arrival times for the scheduled route of the common carrier.

In step 112 the passenger places an order for pickup of baggage items intended to be accepted again by the user upon arrival at a destination. The order may be made and payment may be at the same time and in the same transaction as the travel is ordered and paid, or in a separate transaction. A key component of the present method is that from the standpoint of the passenger the articles are baggage items, and the system is a baggage check system, for which the passenger will receive a baggage claim ticket. Step 112 occurs prior to the formation of a parcel from the articles of baggage items.

A large portion of common carrier reservations are handled by travel agents. Although the parties conducting the transportation of the passenger and the baggage items are the common carrier and the parcel carrier, respectively, there is nothing in the present invention to prevent the service of the present invention being offered by a third party, such as a travel agent. The passenger may pay for the baggage items handling as part of an all-inclusive travel package just as many recreational tours are already marketed.

Furthermore, there is nothing in the foregoing to preclude the common carrier from executing the first steps of the method of the present embodiment of the invention instead of the parcel carrier. The passenger, despite the participation of the parcel carrier, perceives the baggage items handling as a service of the common carrier and not the parcel carrier. It is said then that the parcel carrier's involvement in the process of the present invention is transparent, even though it is a key component of the invention. The passenger makes payment to the common carrier and the parcel carrier is subsequently paid by the common carrier.

In step 120 the order for baggage items pickup is fulfilled by the parcel carrier, who issues one or more baggage items claim checks. This pickup is performed with sufficient lead time for the reconverted baggage items to arrive at the point of pickup by the passenger by the calculation of a lead time window in step 114, and a scheduled baggage items pickup in step 116.

The lead time window is actually a window of time, having a beginning, a duration, and an end with respect to a fixed point in time, such as the time of presentation of baggage items to the passenger, designed for optimum efficiency and convenience under the method, and is an important component of the invention. Since the goal in the present embodiment of the invention is to have the parcel items reconverted to baggage items for presentation at a destination terminal at the same time and under the same or superior conditions as traditional baggage check methods, the lead time window is framed on the one side by the amount of time required for the parcel carrier to complete the method to step 134. By way of example, existing air parcel carriers can and do accurately predict the arrival time of a parcel to their terminal using a coordinated schedule of air and ground transportation. However, nothing in the foregoing process would preclude the use of different modes of transportation for the parcel items as for the passenger. By way of further example, the passenger in the present method may travel by air while the parcel items travel over the road.

The other side of the lead time window is framed by the need for the parcel carrier to control their inventory of parcels. Great efficiency in the parcel carrier systems have been achieved by speeding, not slowing the flow of parcels through their systems. It is readily known that a critical factor in the efficiency of parcel carriers is the inventory of parcels in their system. The faster parcels flow through the parcel carrier system, the greater reduction in the sheer weight and number of parcels borne by the system at any given moment. The parcel carrier makes money by moving the parcels, not storing them. Therefore, the parcel carrier does not wish to accept the baggage items for conversion to parcel items too early before they need to be delivered to the destination terminal.

The convenience of the passenger is another important consideration in determining the lead time window. It is believed that the passenger does not wish to pack baggage items too far ahead of departure, giving over their favorite clothes and toiletries days before being reunited with them at the final destination. If there is some sort of offsetting savings in so doing, a passenger may bear with the inconvenience, but the method of the present invention may still then not attain wide acceptance. On the other hand, there is nothing in the foregoing to preclude the passenger from taking important items in carry-on baggage. It is believed, but in no way intended to preclude any other window amenable to the process of the current invention, that a lead time window of 24 to 48 hours would generally meet all of the above mentioned considerations. By way of further example, if ground transportation of the converted parcel items is desired, either for cost savings or any other reason, a lead time window beginning up to 7 days prior to the passenger's departure time would also be amenable to the process of the present invention.

The passenger gives over possession of the baggage items to the parcel carrier by any known and available means. Existing parcel carrier methods include, but are not limited to: deposit of the parcel at an unmanned drop-box, deposit of the parcel with an employee of the parcel carrier at the counter location of the parcel carrier, or pickup of the parcel by an employee of the parcel carrier at the departure location of the passenger. It is readily apparent to one of ordinary skill in the art of the invention that any of these methods are amenable to use in the present invention. The passenger then receives a baggage check for the baggage items articles instead of a waybill for parcel articles in step 120.

In step 122, which is another key component to the present invention, baggage items are converted to parcel items by the parcel carrier. The tem waybill for purposes of the present specification is intended to mean the paper or electronic record or data record used by the parcel carrier in any form. Baggage checks which have counterparts in the hands of the passenger are matched with one or more waybills for the parcel carrier, which waybills need not be any different from existing waybills used by the parcel carrier, with one exception. Each waybill number is matched with the one or more baggage check numbers that correspond to the baggage items. In this way, there is no requirement that there be a one-to-one correspondence with baggage items and parcel items. There is nothing in the foregoing to prevent more than one baggage item to be consolidated into a single parcel item, or one baggage item to be divided into more than one parcel item. However, it is apparent to one of ordinary skill in the art of the invention that the majority of baggage items given over to the parcel carrier are self-contained, and not amenable to consolidation or division.

Once given over to the parcel carrier in step 120 and converted from a baggage item to a parcel item in step 122, the converted parcel item is transported by the parcel carrier as any other parcel would. The converted parcel item can then be transported as other parcels through the known and available parcel delivery system in step 124.

By way of example, the baggage item could be wrapped in plastic or paper for protection and protect the baggage item from the elements and from pilferage. It is also believed that the passenger will perceive greater security and safety of the baggage items by having the parcel carrier repackage the baggage item in this manner.

It therefore becomes apparent to one of ordinary skill in the art of the invention that by treating the baggage items as a parcel that the parcel need not go through the exhaustive screening that is now required for baggage items to be accompanied by the passenger, and that if given over to the carrier with sufficient time in advance of the passengers departure, there is more time to navigate the baggage screening or parcel screening process.

It therefore becomes further apparent that great convenience has been added to the travel experience of the passenger by the present method. Upon arrival at the common carrier in step 130 the passenger need only have carry-on baggage and does not have to check baggage at a baggage counter. According to other well-known ticketing and transportation methods that reduce the interaction of the user with the common carrier, it is therefore possible to proceed directly through passenger screening methods only and straight to board the common carrier's vehicle.

In step 126, upon arrival at the destination terminal, parcel items are reconverted into the baggage items articles by the parcel carrier, and presented to the passenger for pickup by presentation of the corresponding baggage claim ticket. In the present embodiment of the invention, the parcel carrier has a facility that resembles a baggage claim facility to the perception of the passenger, at the destination terminal of the passenger's travel. There may be a counter or a carousel, in concordance with existing baggage claim methods. Baggage items can be segregated by common carrier route number or by arrival time at the destination terminal for convenience.

It is further readily apparent to one of ordinary skill in the relevant art of the invention that the parcel carrier can also make presenting baggage items in step 134 transparent to the passenger, just as the baggage item pickup in step 120 can be made transparent to the passenger. The parcel carrier can give the reconverted baggage items back to the common carrier to be placed with the baggage of other passengers not using the method, and the baggage claim can proceed without any changes. In this manner, baggage items are presented to the passenger, which presentation need not appear any different than the presentation already employed by the common carrier.

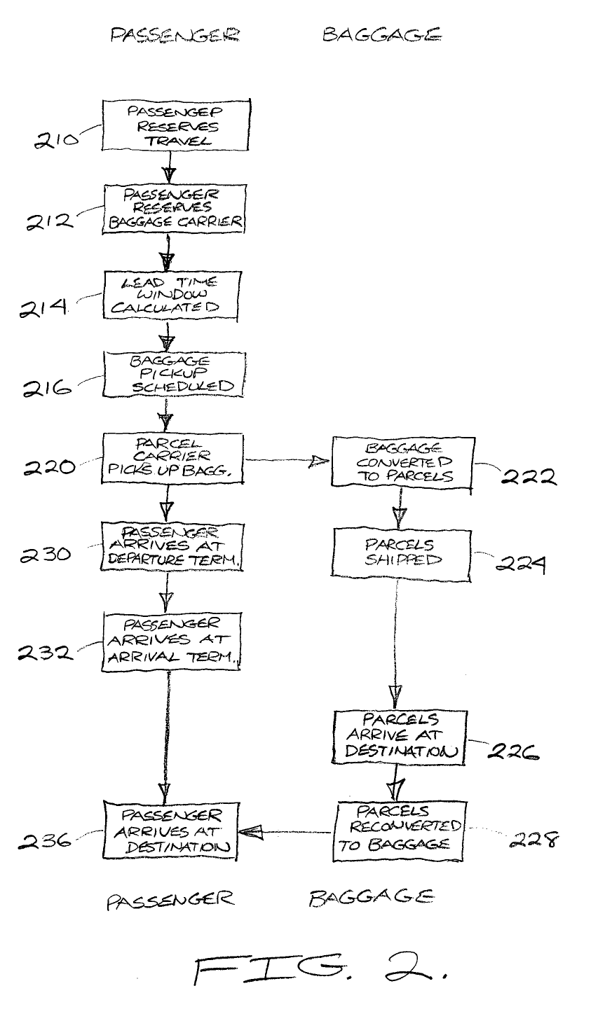

Referring now to FIG. 2, and in a second preferred embodiment of the present invention, the initial steps of the method are the same as in the first embodiment. A passenger reserves travel over a common carrier in step 210 and orders baggage service from a parcel carrier in step 212, which order for baggage service is fulfilled in step 220, by way of the novel steps of the method comprising calculating a lead time window in step 214 and scheduling pickup with the parcel carrier in step 216, and one or more baggage claim tickets are issued. The parcel carrier converts the baggage items into parcel items in step 222, and commits them to the parcel transportation system to be transported in step 224.

The passenger then arrives for travel at the common carrier departure terminal in step 230, and conducts the travel to arrive at the destination terminal of the common carrier in step 232. It is from here that the present embodiment departs from the first embodiment.

The process of the present embodiment differs in inception from the embodiment of FIG. 1 in that the passenger acquires confirmation information regarding the destination. The intent in the present embodiment is for the parcel carrier to deliver the baggage items directly to the destination location of the passenger, such as a hotel or office, in step 226. It is in this embodiment that the confirmation number for a hotel or resort can be matched to the baggage claim number on the baggage item. The passenger then experiences, similar to the first embodiment of FIG. 1, a baggage claim check experience. In this embodiment, the confirmation number may match the waybill number or baggage claim number, and the passenger can then claim the baggage item, in step 228.

The parcel carrier agent gets confirmation number information from the passenger, either when the request for pickup of the baggage is made, which the passenger would have received in advance of travel and in advance of the pick-up window. Comparing this to the well known and ad hoc method increasingly used by passengers of taking baggage items articles to a parcel carrier for shipment, several advantages may be seen both from the standpoint of the common carrier as well as for the passenger. From the standpoint of the common carrier, there is a lot of infrastructure associated with baggage handling that my be reduced or eliminated under the method of the present invention.

Common carrier passenger safety, which is of acute importance today for airlines but not at all irrelevant for other kinds of common carriers, is also advanced by the method. There is believed to be less incentive to use the baggage system for the deposit of explosives in a terrorist act if the baggage articles are not transported by the common carrier at all.

Some of the advantages of the present invention have been described above, namely the added passenger security for common carriers in segregating passengers from baggage, and the convenience the passenger experiences in not having to carry baggage throughout the travel. Further advantages include the reduced cost of common carrier travel by giving over time consuming and labor intensive baggage handling tasks to an entity, namely the parcel carrier, that has already developed sophisticated and efficient processes for handling parcels. Common carriers also save fuel by carrying less freight for a further savings in operating costs. Passengers also benefit under the present invention by having total costs of common carrier travel that are influenced by the amount of baggage they bring with them.

Furthermore, modern parcel carrier companies permit parcel tracking by a variety of methods, which are amenable for use to track baggage items. Processes at the terminals of common carrier systems, such as airports, train stations, bus terminals, and passenger port terminals, also benefit under the present method by not having to handle baggage. The result is that baggage-related delays and passenger complaints about baggage handling are reduced as well.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

What is claimed is:

1. In the context of passenger travel over a common carrier by a passenger having one or more baggage items at a departure location, and wherein said passenger is transported by the common carrier from a departure terminal location to a destination terminal location then proceeds to arrival at a destination location, a process for handling said baggage comprising the steps of:
calculating a lead time window,
accepting said baggage items from said passenger during the duration of the lead time window,
converting said baggage items into one or more parcel items,
transport of said parcel items by a parcel carrier from said departure location to said destination terminal location; and
reconverting said parcel items into baggage items for presentation.

2. The process of claim 1, wherein the step of accepting said baggage items is performed by said parcel carrier.

3. The process of claim 1, wherein the step of accepting said baggage items is performed by said common carrier, and further comprising the step of delivering said baggage items accepted by the common carrier to said parcel carrier.

4. The process of claim 1, wherein said lead time window has a beginning no greater than seven days from the time of presentation of said baggage items to said passenger.

5. The process of claim 1, wherein said lead time window has a beginning no greater than 48 hours from the time of presentation of said baggage items to said passenger.

6. In the context of passenger travel over a common carrier by a passenger having one or more baggage items at a departure location, and wherein said passenger is transported by the common carrier from a departure terminal location to a destination terminal location then proceeds to arrival a destination location, a process for handling said baggage comprising the steps of:
calculating a lead time window,
accepting said baggage items from said passenger during the duration of the lead time window,
converting said baggage items into one or more parcel items,
transport of said parcel items from said departure location to said destination location; and
reconverting said parcel items into baggage items for presentation.

7. The process of claim 6, wherein the step of accepting said baggage items is performed by said parcel carrier.

8. The process of claim 6, wherein the step of accepting said baggage items is performed by said common carrier, and further comprising the step of delivering said baggage items accepted by the common carrier to said parcel carrier.

9. The process of claim 6, wherein said lead time window has a beginning no greater than seven days from the time of presentation of said baggage items to said passenger.

10. The process of claim 6, wherein said lead time window has a beginning no greater than 48 hours from the time of presentation of said baggage items to said passenger.
